(19) United States
(12) Patent Application Publication
(10) Pub. No.: US 2025/0101728 A1
(43) Pub. Date: Mar. 27, 2025

(54) TOILET BOWL CLEANING DEVICE AND CLEANING METHOD USING THE SAME

(71) Applicant: Kohler Novita Ltd., Chungcheongnam-do (KR)

(72) Inventors: Jongsik Kim, Chungcheongnam-do (KR); Byungho Lee, Chungcheongnam-do (KR)

(21) Appl. No.: 18/897,620

(22) Filed: Sep. 26, 2024

(30) Foreign Application Priority Data
Sep. 27, 2023 (KR) 1020230130357

(51) Int. Cl. E03D 9/02; B08B 9/00

(52) U.S. Cl. CPC E03D 9/02; B08B 9/00

(57) ABSTRACT

A toilet bowl cleaning device includes a cleaning nozzle portion disposed on a bottom surface of a bidet body of a toilet, the cleaning nozzle portion configured to extend and horizontally rotate, and the cleaning nozzle portion including a water intake portion and a water outlet portion. The device also includes a nozzle head disposed on the water outlet portion of the cleaning nozzle portion and configured to spray cleaning water or a disinfectant onto a surface of a bowl of the toilet through a spray hole of the nozzle head. The nozzle head comprises a spray guide portion configured to guide a discharged flow of the cleaning water or the disinfectant in a zigzag manner so that the cleaning water or the disinfectant is sprayed in an up-down swing manner through the spray hole.

### CROSS REFERENCE TO RELATED APPLICATION

This application claims the benefit of priority to: Korean Patent Application No. 10-2023-0130357 filed in the Korean Intellectual Property Office on Sep. 27, 2023, which is hereby incorporated by reference in its entirety.

### FIELD

The present disclosure relates to the technology of cleaning a bowl of a toilet. More particularly, the present disclosure relates to a toilet bowl cleaning device and a cleaning method using the toilet bowl cleaning device, in which a cleaning nozzle portion that is controlled in a sequence operating mode sprays cleaning water or a disinfectant in an up-down swing manner, so that a physical impact can be applied to a surface of the bowl of the toilet, thereby effectively cleaning the surface of the bowl of the toilet without blind areas.

### BACKGROUND

Generally, a bidet refers to a device that sprays cleaning water to the anus and/or its local area and periphery of a user by means of a nozzle device after defecation. The bidet is arranged on a toilet and includes a bidet body that combines a seat cushion with a seat cover, an operating portion, a cleaning nozzle portion that sprays cleaning water onto the anus and/or its local area and periphery of the user, and the like.

In an embodiment, the toilet (or a pedestal pan) equipped with the bidet has a ceramic structure, and foreign matter still remains on a surface of a bowl of the toilet after flushing. Thus, there may be a source of pollution for generating, for example, scale, and bacterial reproduction may be caused to give rise to odor and an unpleasant smell when defecating, failing to provide comfortable environment for the user.

In this regard, in the past, as disclosed in the Korean Patent Publication No. 10-2017-0133053, a toilet cleaning device is provided which has a cleaning nozzle portion for cleaning a bowl, which is arranged on a shell and has a spray hole. The toilet cleaning device includes a lifting unit and a rotating unit, which may cause the cleaning nozzle portion to extend and horizontally rotate.

However, even if the cleaning nozzle portion of the toilet cleaning device disclosed in the existing patent is caused to extend by the lifting unit and to horizontally rotate by the rotating unit, because the way of spraying cleaning water through the spray hole of the cleaning nozzle portion is direct-shot, there is a limitation in cleaning the surface of the toilet bowl by using cleaning water sprayed through the spray hole of the cleaning nozzle portion. Inevitably, there is a blind area on the surface of the toilet bowl that cannot be cleaned.

In other words, the nozzle portion rotates in a horizontal direction after extending from the front end of the bidet body, and when the cleaning water is sprayed in a direct-shot manner through the spray hole, the cleaning water in the direct-shot manner cannot apply a physical impact onto the surface of the toilet bowl. Thus, the source of pollution, such as foreign matter and/or scale solidified on the surface of the toilet bowl, cannot be cleaned satisfactorily.

Moreover, the cleaning nozzle portion simply sprays cleaning water onto the surface of the toilet bowl and does not realize a sequence operating mode of dividing the surface of the toilet bowl into an integral cleaning area or partial cleaning areas and sequentially cleaning these areas. Thus, this inevitably leads to a reduction in the efficiency of removing the source of pollution on the surface of the toilet bowl and causing inconvenience that in the past. The user needs to personally re-clean the surface of the toilet bowl with a cleaning brush.

### SUMMARY

### Technical Problems to be Solved

The present disclosure aims to provide a toilet bowl cleaning device and a toilet bowl cleaning method using the toilet bowl cleaning device. In the toilet bowl cleaning device and the toilet bowl cleaning method, a cleaning nozzle portion that is controlled in a sequence operating mode sprays cleaning water or a disinfectant in an up-down swing manner. The toilet bowl cleaning device and the toilet bowl cleaning method may improve the efficiency of removing foreign matter from a surface of a toilet bowl by applying a physical impact onto the surface of the toilet bowl with the up-down swing cleaning water or disinfectant. The toilet bowl cleaning device and the toilet bowl cleaning method may minimize a cleaning blind area by enlarging the range of cleaning and/or disinfection on the surface of the toilet bowl. Thus, the sanitation of a toilet may be improved.

### Solutions to Technical Problems

According to an embodiment of the present disclosure, the toilet bowl cleaning device includes a cleaning nozzle portion formed on one side of a bottom surface of a bidet body combined with a toilet. The cleaning nozzle portion extends and horizontally rotates. The cleaning nozzle portion has a water intake portion formed at one end and a water outlet portion formed at the other end. The toilet bowl cleaning device also includes a nozzle head formed on the side of the water outlet portion of the cleaning nozzle portion and spraying cleaning water or a disinfectant to a surface of a bowl of the toilet through a spray hole. The nozzle head is provided with a spray guide portion to guide a discharged flow of the cleaning water or the disinfectant in a zigzag manner, so that the cleaning water or the disinfectant is sprayed in an up-down swing manner through the spray hole.

In an embodiment, the cleaning nozzle portion includes: a first cylindrical portion provided with the water intake portion connected to a cleaning water supply pipeline in the bidet body and having a first internal flow path; a second cylindrical portion configured to form the water outlet portion and having a second internal flow path in communication with the first internal flow path; and a connecting portion, which protrudes at one end of the second cylindrical portion, is configured to guide an inserting combination of the first cylindrical portion and has a third internal flow path in communication with the first internal flow path and the second internal flow path.

In an embodiment, an opening is formed in an outer peripheral surface of the first cylindrical portion, a key slot is formed in an outer peripheral surface of the connecting portion, and a key for fixing the first cylindrical portion and the connecting portion is placed in the opening and the key slot.

In an embodiment, the opening is of a C-shaped hole structure, and the key is of a C-shaped ring structure placed in the connecting portion through the opening.

In an embodiment, a sealing gasket groove is formed in the outer peripheral surface of the connecting portion, and a sealing gasket clung to an inner peripheral surface of the first cylindrical portion is placed in the sealing gasket groove.

In an embodiment, the water outlet portion is of a slot structure, is in communication with the second internal flow path of the second cylindrical portion, serves as an installation space for the cleaning water or the disinfectant to flow in, and is configured to place the nozzle head by insertion. The nozzle head is provided with a water intake hole in communication with the installation space. The spray guide portion is formed between the water intake hole and the spray hole.

In an embodiment, the spray guide portion is a ribbed block, is in communication with the water intake hole to spray the cleaning water or the disinfectant from the spray hole in an up-down swing manner, and is provided with a drainage chamber to guide the discharged flow of the cleaning water or the disinfectant in a zigzag manner.

According to an embodiment of the present disclosure, a toilet bowl cleaning method executed by the toilet bowl cleaning device includes step a of controlling, according to an input signal of a cleaning button, a water supply valve in a bidet body to be opened to supply cleaning water. The method also includes step b of heating the cleaning water by activating a water heater in the bidet body when the cleaning water is supplied into the bidet body in step a. The method also includes step c of, when the cleaning water heated by the water heater reaches a target water temperature in step b, spraying the cleaning water or a disinfectant onto a surface of the bowl in an up-down swing manner by controlling a plurality of sequence operating modes to apply a physical impact onto the surface of the bowl of a toilet for cleaning or disinfection. The plurality of sequence operating modes is configured to determine whether the disinfectant is introduced into the cleaning nozzle portion and whether air is mixed in, and to change an extended distance and a horizontal rotation angle of the cleaning nozzle portion.

In an embodiment, in step c, the plurality of sequence operating modes includes a soaking mode, a cleaning mode, a deep cleaning mode, a flushing mode, and a disinfecting mode, which are sequentially executed.

In an embodiment, in step c, the soaking mode is a mode of soaking a source of pollution attached to the surface of the bowl of the toilet. Executing the soaking mode includes a first step of causing the cleaning nozzle portion stored on one side of a bottom surface of the bidet body to extend. Executing the soaking mode includes a second step of, as the cleaning nozzle portion, which extends in the first step reciprocates from an initial rotation angle to a maximum rotation angle to rotate horizontally, guiding a discharged flow in a zigzag manner by a spray guide portion in the nozzle head, and repeatedly spraying the heated cleaning water onto the surface of the bowl in an up-down swing manner through a spray hole. Executing the soaking mode includes a third step of, when the heated cleaning water is repeatedly sprayed onto the surface of the bowl in an up-down swing manner by reciprocating horizontal rotations of the cleaning nozzle portion in the second step, causing the cleaning nozzle portion to return to the initial rotation angle after the cleaning nozzle portion stops rotating horizontally.

In an embodiment, in step c, the cleaning mode is a mode of primarily removing, by means of brushing, the soaked source of pollution on the surface of the bowl of the toilet after the soaking mode. Executing the cleaning mode includes a fourth step of, in order to make the cleaning nozzle portion, which has extended repeatedly rotate horizontally by a first rotation angle and rotate horizontally by a second rotation angle smaller than the first rotation angle, dividing the surface of the bowl into partial areas, repeatedly cleaning the partial areas, guiding the discharged flow in a zigzag manner by the spray guide portion in the nozzle head, and repeatedly spraying the heated cleaning water in an up-down swing manner through the spray hole. Executing the cleaning mode includes a fifth step of, when the cleaning nozzle portion repeatedly spraying the heated cleaning water in an up-down swing manner in the fourth step reaches a maximum rotation angle through repeated horizontal rotations by the first rotation angle and the second rotation angle, causing the cleaning nozzle portion to return to the initial rotation angle after the cleaning nozzle portion stops rotating horizontally.

In an embodiment, in step c, the deep cleaning mode is a mode of secondarily removing, by means of brushing, the source of pollution on the surface of the bowl of the toilet after the cleaning mode. Executing the deep cleaning mode includes a sixth step of causing the cleaning nozzle portion to reciprocate within a range of the first rotation angle to rotate horizontally, guiding the discharged flow in a zigzag manner by a spray guide portion in the nozzle head, and repeatedly spraying the heated cleaning water onto an upper side surface and a lower side surface of the bowl in an up-down swing manner through the spray hole. Executing the deep cleaning mode includes a seventh step of causing the cleaning nozzle portion to return to the initial rotation angle after the cleaning nozzle portion stops rotating horizontally in the sixth step. Executing the deep cleaning mode includes an eighth step of, from the seventh step, causing the cleaning nozzle portion to reciprocate within a range of the second rotation angle to rotate horizontally, guiding the discharged flow in a zigzag manner by the spray guide portion in the nozzle head, and repeatedly spraying the heated cleaning water onto a left side surface and a right side surface of the bowl in an up-down swing manner through the spray hole. Executing the deep cleaning mode includes a ninth step of causing the cleaning nozzle portion to return to the initial rotation angle after the cleaning nozzle portion stops rotating horizontally in the eighth step, and repeatedly executing the sixth to ninth steps for a preset number of times.

In an embodiment, in step c, the flushing mode is a mode of removing the source of pollution remaining on the surface of the bowl of the toilet after the source of pollution is removed by the deep cleaning mode. Executing the flushing mode includes a tenth step of keeping the water heater activated or deactivating the water heater from step b to heat or not to heat the cleaning water. Executing the flushing mode includes an eleventh step of, from the ninth step, causing the cleaning nozzle portion to rotate horizontally by the maximum rotation angle, guiding the discharged flow in a zigzag manner by the spray guide portion in the nozzle head, and repeatedly spraying the heated cleaning water or unheated room-temperature cleaning water onto the surface of the bowl in an up-down swing manner through the spray hole.

In an embodiment, in step c, the disinfecting mode is a mode of disinfecting the surface of the bowl of the toilet from which the residual source of pollution is removed by the flushing mode. Executing the disinfecting mode includes a twelfth step of, when the water heater is kept activated or is deactivated in the tenth step, activating a disinfectant generating portion arranged inside the bidet body to generate a disinfectant, and heating or not heating the disinfectant. Executing the disinfecting mode includes a thirteenth step of, from the eleventh step, causing the cleaning nozzle portion to rotate horizontally, guiding the discharged flow in a zigzag manner by the spray guide portion in the nozzle head, and repeatedly spraying the heated disinfectant or an unheated room-temperature disinfectant onto the surface of the bowl in an up-down swing manner through the spray hole. Executing the disinfecting mode includes a fourteenth step of, when the water heater is activated in the twelfth step, controlling the water supply valve that is controlled to be opened in step a to be closed after deactivating the water heater and the disinfectant generating portion.

In an embodiment, in step c, in the soaking mode, the cleaning mode, and the deep cleaning mode, the heated cleaning water sprayed in an up-down swing manner through the spray hole is warm water within a range of 35° C. to 75° C.

In an embodiment, in step c, in the flushing mode and the disinfecting mode, the heated or unheated cleaning water sprayed in an up-down swing manner through the spray hole is warm water within a range of 35° C. to 75° C. or room-temperature water.

In an embodiment, the toilet bowl cleaning method further includes the following step: in step c, in the soaking mode, the cleaning mode, the deep cleaning mode, the flushing mode, and the disinfecting mode, when the cleaning water flows into the nozzle head, mixing in air by an air pump arranged inside the bidet body.

In an embodiment, in step c, an air mixing volume in the soaking mode, the flushing mode, and the disinfecting mode is a first mixing volume, and an air mixing volume in the cleaning mode and the deep cleaning mode is controlled to be a second mixing volume greater than the first mixing volume.

In an embodiment, in the disinfecting mode of step c, the disinfectant generated by the disinfectant generating portion is electrolyzed water generated by electrolysis.

In an embodiment, in step c, the cleaning nozzle portion rotates within a range of 0° to 360° from the initial rotation angle to the maximum rotation angle.

In an embodiment, in step c, the maximum extended distance of the cleaning nozzle portion is 180 mm or less.

### Effects of the Present Disclosure

As described above, in the present disclosure, a cleaning nozzle portion is controlled in a sequence operating mode to spray cleaning water or a disinfectant in an up-down swing manner. This may improve the efficiency of removing foreign matter from a surface of a toilet bowl by applying a physical impact to the surface of the toilet bowl with the up-down swing cleaning water or disinfectant. This may also minimize a cleaning blind area by enlarging the range of cleaning and/or disinfection on the surface of the toilet bowl. Thus, the sanitation of a toilet may be improved. By optimizing the structure of the toilet bowl cleaning device, the product cost is reduced.

The effects of the present disclosure are not limited to the above, and other effects not mentioned can be clearly understood by those having ordinary skill in the art from the recitation of the claims.

### BRIEF DESCRIPTION OF THE FIGURES

FIG. 1 is a structural diagram of a toilet bowl cleaning device applied to a bidet body according to an embodiment of the present disclosure.

FIG. 2 is a schematic sectional view of a nozzle portion of the toilet bowl cleaning device that is stored according to an embodiment of the present disclosure.

FIG. 3 is a schematic sectional view of the nozzle portion of the toilet bowl cleaning device that has extended according to an embodiment of the present disclosure.

FIG. 4 is an enlarged perspective view of a structure of the nozzle portion according to an embodiment of the present disclosure.

FIG. 5 is an enlarged sectional view of the structure of the nozzle portion according to an embodiment of the present disclosure.

FIG. 6 is an overall flow chart showing a method for cleaning a surface of a toilet bowl in a sequence operating mode according to an embodiment of the present disclosure.

FIG. 7 is a flow chart of the surface of the toilet bowl being cleaned in a soaking mode as a sequence operating mode according to an embodiment of the present disclosure.

FIG. 8 is a flow chart of the surface of the toilet bowl being cleaned in a cleaning mode as a sequence operating mode according to an embodiment of the present disclosure.

FIG. 9 is a flow chart of the surface of the toilet bowl being cleaned in a deep cleaning mode as a sequence operating mode according to an embodiment of the present disclosure.

FIG. 10 is a flow chart of the surface of the toilet bowl being cleaned in a flushing mode as a sequence operating mode according to an embodiment of the present disclosure.

FIG. 11 is a flow chart of the surface of the toilet bowl being cleaned in a disinfecting mode as a sequence operating mode according to an embodiment of the present disclosure.

FIG. 12 is a graph schematically showing a rotation range between an initial rotation angle and a maximum rotation angle of the nozzle portion that is extending or has extended when the surface of the toilet bowl is cleaned in the soaking mode according to an embodiment of the present disclosure.

FIG. 13 is a graph schematically showing a horizontal rotation range for the nozzle portion that is extending or has extended when the surface of the toilet bowl is cleaned in the cleaning mode according to an embodiment of the present disclosure.

FIG. 14 is a graph schematically showing a horizontal rotation range for the nozzle portion that is extending or has extended when the surface of the toilet bowl is cleaned in the deep cleaning mode according to an embodiment of the present disclosure.

FIG. 15 is a graph schematically showing a rotation range between an initial rotation angle and a maximum rotation angle of the nozzle portion that is extending or has extended when the surface of the toilet bowl is cleaned in the flushing mode according to an embodiment of the present disclosure.

FIG. 16 is a graph schematically showing a rotation range between an initial rotation angle and a maximum rotation angle of the nozzle portion that is extending or has extended when the surface of the toilet bowl is disinfected in the disinfecting mode according to an embodiment of the present disclosure.

FIG. 17 is a block diagram of a controller according to an embodiment of the present disclosure.

FIG. 18 is a block diagram of a toilet bowl cleaning device comprising the controller according to an embodiment of the present disclosure.

### DETAILED DESCRIPTION

The advantages and features of the present disclosure and methods for achieving same should become more apparent with reference to the embodiments described in detail below together with the drawings. However, the embodiments of the present disclosure are not limited to the embodiments disclosed below but can be implemented in various forms. The embodiments are merely intended to make the descriptions of the present disclosure complete and fully convey the scope of the present disclosure to those having ordinary skill in the art to which the present disclosure pertains. The embodiments of the technical concept of the present disclosure are merely defined by the scope of the claims.

The terms used in the present disclosure are merely used to explain the embodiments, rather than limit the present disclosure. In the present disclosure, the singular form includes the plural form unless specified in the context otherwise.

In the present disclosure, it should be understood that the terms, such as “include” or “have”, are used to specify the existence of features, numbers, steps, actions, structural elements, components or the combinations thereof recited in the present disclosure, rather than pre-excluding the existence or additional possibility of one or more other features, numbers, steps, actions, structural elements, components or the combinations thereof.

Furthermore, the embodiments described in the present disclosure are explained with reference to the ideal exemplary cross-sectional view and/or top view of the present disclosure. Therefore, the embodiments of the present disclosure are not limited to the specific forms shown but also include necessary form modifications. For example, an area represented by a right angle may have a circular arc shape or a shape having a specified curvature. Therefore, the area shown in the figure has schematic properties, and the shape of the area shown in the figure is intended to illustrate the specific shape of the area of a device, rather than limit the scope of the present disclosure.

Throughout the present disclosure, the same reference numerals represent the same or equivalent structural elements. Therefore, even if the reference numerals are not mentioned or explained in the corresponding drawings, the reference numerals may be explained with reference to the same reference numerals or similar reference numerals in other drawings. In addition, even if the reference numerals are not shown, the reference numerals may be explained with reference to other drawings. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

The embodiments of the present disclosure are described below with reference to the drawings.

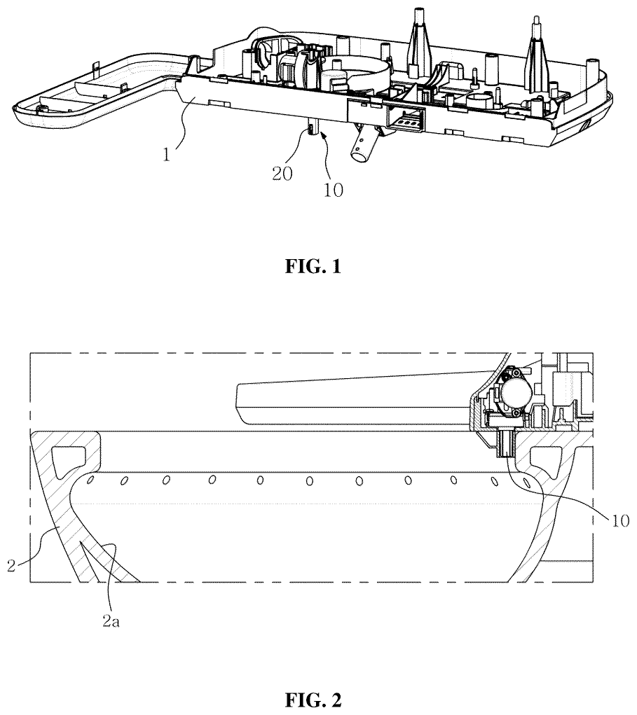

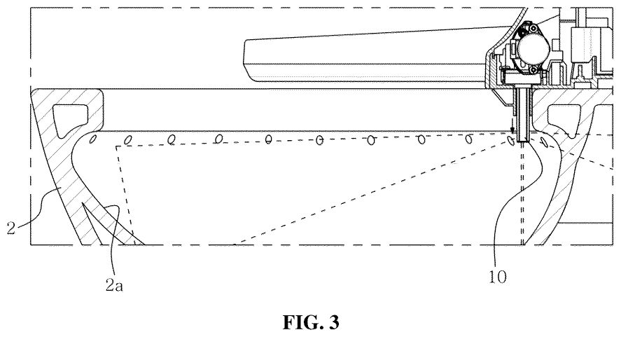

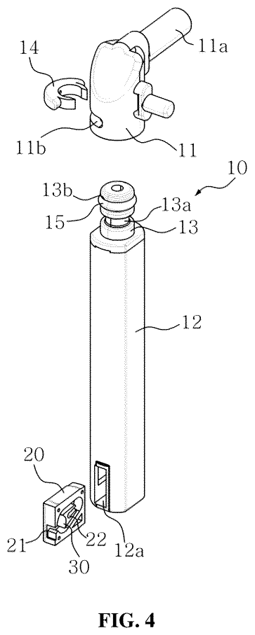

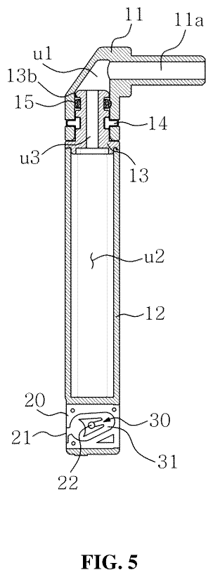

FIG. 1 is a structural diagram of a toilet bowl cleaning device applied to a bidet body according to an embodiment of the present disclosure. FIG. 2 is a schematic sectional view of a nozzle portion of the toilet bowl cleaning device that is stored according to an embodiment of the present disclosure. FIG. 3 is a schematic sectional view of the nozzle portion of the toilet bowl cleaning device that has extended according to an embodiment of the present disclosure. FIG. 4 is an enlarged perspective view of a structure of the nozzle portion according to an embodiment of the present disclosure. FIG. 5 is an enlarged sectional view of the structure of the nozzle portion according to an embodiment of the present disclosure.

Referring to FIGS. 1-5, in the toilet bowl cleaning device according to the embodiments of the present disclosure, a water supply valve provided in a cleaning water supply pipeline connected to a bidet body 1 is controlled by a bidet control portion to remove a source of pollution, such as foreign matter or scale attached to the surface of a bowl 2a of a toilet 2. The source of pollution may be removed by spraying cleaning water flowing in at startup or by spraying a disinfectant generated by a disinfectant generating portion controlled by the bidet control portion. For example, a disinfectant (electrolyzed water) may be generated by electrolysis, which is heated by a water heater that is activated. Alternatively, the source of pollution may be removed by spraying unheated room-temperature cleaning water or an unheated room-temperature disinfectant. The cleaning water, the disinfectant, the unheated room-temperature cleaning water, the unheated room-temperature disinfectant may be sprayed onto the bowl 2a or may be mixed with air supplied by an air pump for spraying. The toilet bowl cleaning device includes a cleaning nozzle portion 10, a nozzle head 20, and a spray guide portion 30.

The cleaning water supply pipeline, the water supply valve, the water heater, the disinfectant generating portion, the air pump and the bidet control portion are well known from the bidet body 1 as disclosed in the Korean Patent Publication No. 10-2023-0045330 filed by the inventor. Thus, the detailed descriptions are omitted herein.

As shown in FIG. 2, the cleaning nozzle portion 10 is stored on one side of a bottom surface of the bidet body 1 combined with (e.g., connected to) the toilet 2, as shown in FIG. 3, can simultaneously extend and horizontally rotate, or sequentially horizontally rotate after the extension. The cleaning nozzle portion 10 may include a first cylindrical portion 11, a second cylindrical portion 12, and a connecting portion 13.

The storage or extension and horizontal rotation of the cleaning nozzle portion 10 is/are realized by a well-known lifting unit in a form of a cylinder controlled by the bidet control portion and a well-known rotating unit driven by means of transmission, which is disclosed in the Korean Patent Application No. 10-2023-0039589 (filed on Mar. 27, 2023) filed by the inventor. Thus, the detailed descriptions are omitted herein.

The first cylindrical portion 11 has an L-shaped hollow cylindrical structure, is configured to form a water intake portion 11a connected to a cleaning water supply pipeline in the bidet body 1, and has a first internal flow path U1 for cleaning water to flow therein.

The second cylindrical portion 12 has a hollow cylinder structure, is configured to form a water outlet portion 12a, and has a second internal flow path U2 in communication with the first internal flow path U1 for cleaning water to flow therein.

The water outlet portion 12a has a slot structure, is in communication with the second internal flow path U2 of the second cylindrical portion 12, serves as an installation space for cleaning water to flow therein, and is configured to place the nozzle head 20 by insertion.

The connecting portion 13 protrudes at one end of the second cylindrical portion 12, is configured to guide an inserting combination of the first cylindrical portion 11, has a key slot 13a and a 13b formed on an outer peripheral surface, and has a third internal flow path U3 in communication with the first internal flow path U1 and the second internal flow path U2.

In an embodiment, an opening 11b may be formed in an outer peripheral surface of the first cylindrical portion 11, so that a key 14 is placed in the key slot 13a through the opening 11b, and the key 14 is configured to connect and fix the first cylindrical portion 11 and the connecting portion 13.

Furthermore, the sealing gasket groove 13b may be configured to place a sealing gasket 15 clung to (e.g., closely contacted to) an inner peripheral surface of the first cylindrical portion 11, so that the opening 11b has a C-shaped hole structure, the key 14 may have a C-shaped ring structure and is placed in the key slot 13a through the opening 11b, and the sealing gasket 15 may have an O-ring structure and may be in the form of a closed ring clung to the inner peripheral surface of the first cylindrical portion 11.

The nozzle head 20 is inserted into and combined with (e.g., connected to) the water outlet portion 12a having a slot structure as an installation space of the cleaning nozzle portion 10 and sprays cleaning water or a disinfectant onto the surface of the bowl 2a of the toilet 2 through the spray hole 21. Thus, the nozzle head 20 may be provided with a water intake hole 22 in communication with the installation space, and the spray guide portion 30 may be formed between the water intake hole 22 and the spray hole 21.

The spray guide portion 30 is formed on the nozzle head 20 to guide a discharged flow of the cleaning water or the disinfectant in a zigzag manner, so that the cleaning water or the disinfectant may be sprayed in an up-down swing manner through the spray hole 21.

Specifically, the spray guide portion 30 is a ribbed block and is provided with a drainage chamber 31 in communication with the water intake hole 22, so that the cleaning water or the disinfectant may be sprayed in an up-down swing manner through the spray hole 21. The spray guide portion 30 guides a discharged flow of the cleaning water or the disinfectant in a zigzag manner through the drainage chamber 31. Therefore, when sprayed through the spray hole 21, the cleaning water or the disinfectant may be sprayed in an up-down swing manner, so as to apply a physical impact onto the surface of the bowl 2a of the toilet 2.

As described above, in the toilet bowl cleaning device according to the embodiments of the present disclosure, the nozzle head 20 formed at the other end of the cleaning nozzle portion 10 in an integrated structure or a separate structure constitutes the spray guide portion 30, which serves as a ribbed block and is provided with the drainage chamber 31. The spray guide portion 30 guides, in a zigzag manner, the discharged flow of the cleaning water or the disinfectant introduced through the water intake hole 22 of the nozzle head 20. Thus, the cleaning water or the disinfectant may be sprayed onto the surface of the bowl 2a of the toilet 2 in an up-down swing manner through the spray hole 21 of the nozzle head 20. Therefore, as the up-down swing cleaning water or disinfectant applies a physical impact onto the surface of the bowl 2a of the toilet 2, the source of pollution, such as foreign matter or scale attached to the surface of the bowl 2a, can be effectively removed.

In an embodiment, the toilet bowl cleaning device described with reference to FIGS. 1-5 can be controlled to perform a toilet bowl cleaning method for cleaning, according to a sequence operating mode, by the bidet control portion provided in the bidet body 1, which is described in detail with reference to FIGS. 1-16.

First, in step a, the method determines whether an input is received from a cleaning button. When the bidet control portion receives an input signal of a cleaning button provided in an operating portion of the bidet body 1, the bidet control portion realizes supply of cleaning water by controlling a water supply valve in the bidet body 1 to be opened.

Next, in step b, when an input is received from a cleaning button (Y in step a), the method determines whether a target water temperature is reached. When the cleaning water is supplied to the bidet body 1, the bidet control portion keeps, by activating or deactivating a water heater in the bidet body 1, the cleaning water in a warm water state with a target water temperature within the range of 35° C. to 75° C. (desirably 40° C.), or in a room-temperature water state.

Afterwards, in step c, when the unheated room-temperature water or the cleaning water heated by the water heater reaches the target water temperature (Y in step b), the bidet control portion controls a plurality of sequence operating modes to apply a physical impact onto the surface of the bowl 2a of the toilet 2 by spraying the cleaning water or the disinfectant onto the surface of the bowl 2a in an up-down swing manner. Thus, cleaning or disinfection may be realized. The plurality of sequence operating modes is intended to determine whether the disinfectant is introduced into the cleaning nozzle portion 10 stored on one side of the bottom surface of the bidet body 1 and whether air is mixed in. The plurality of sequence operating modes is intended to change an extended distance and a horizontal rotation angle of the cleaning nozzle portion 10.

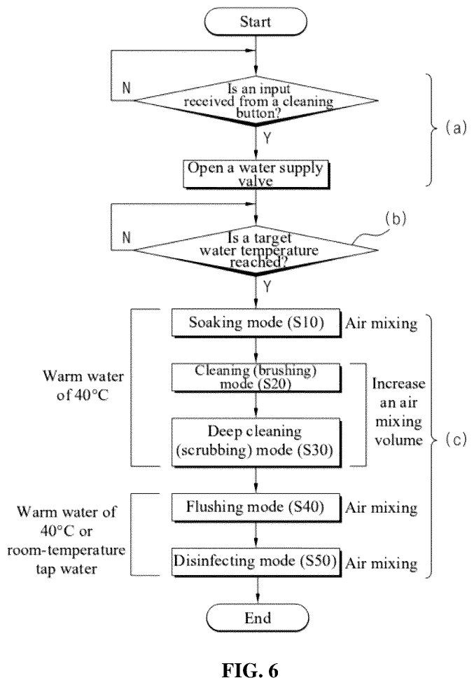

In other words, as shown in FIG. 6, the sequence operating modes controlled by the bidet control portion are sequentially executed in the order of a soaking mode S10→a cleaning mode S20→a deep cleaning mode S30→a flushing mode S40→a disinfecting mode S50, and each operating mode is described in detail below.

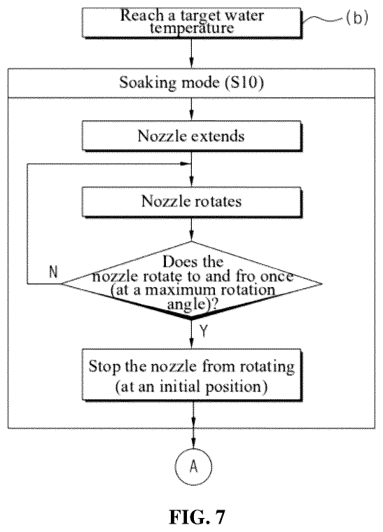

As shown in FIG. 7, the soaking mode S10 is a mode of soaking a source of pollution attached to the surface of the bowl 2a of the toilet 2 and may include the first to third steps.

As shown in FIG. 3, in the first step, a lifting unit is controlled to drive the cleaning nozzle portion 10 stored on one side of the bottom surface of the bidet body 1 to extend downwardly after step b.

A maximum extended distance of the cleaning nozzle portion 10, achieved by the lifting unit, may be 180 mm or less.

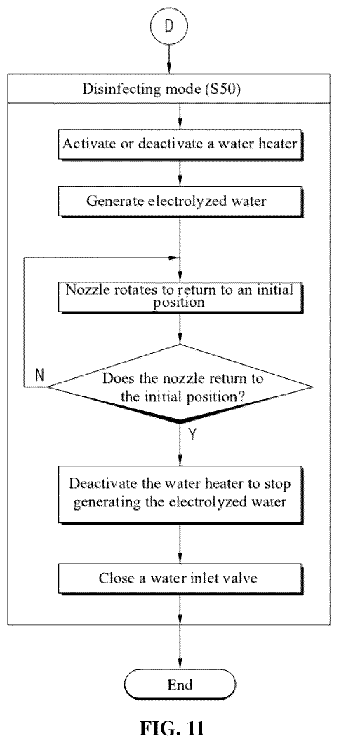

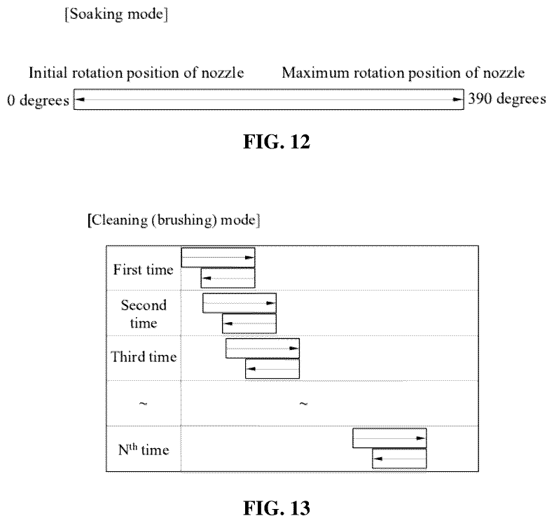

Next, as shown in FIG. 12, in the second step, a rotating unit is controlled to drive the cleaning nozzle portion 10 that has extended to reciprocate from an initial rotation angle (for example, 0°) 0° to a maximum rotation angle (for example, 0°) 360° for horizontal rotation.

At this time, extension and horizontal rotation of the cleaning nozzle portion 10 can be realized at the same time or the horizontal rotation can be performed after the extension. When the cleaning nozzle portion 10 rotates horizontally, the cleaning water flowing through the water intake portion 11a of the first cylindrical portion 11 of the cleaning nozzle portion 10 can be discharged from the water outlet portion 12a via the first internal flow path U1, the third internal flow path U3 of the connecting portion 13, and the second internal flow path U2 of the second cylindrical portion 12.

Furthermore, the cleaning water discharged in the above way flows into the drainage chamber 31 of the spray guide portion 30 in the nozzle head 20 through the water intake hole 22 of the nozzle head 20 formed in the water outlet portion 12a, and the discharged flow of the cleaning water is guided in a zigzag manner. Thus, the cleaning water heated to be within the range of 35° C. to 75° C. (desirably 40° C.) is repeatedly sprayed onto the surface of the bowl 2a of the toilet 2 in an up-down swing manner through the spray hole 21 of the nozzle head 20 to soak the source of pollution on the surface of the bowl 2a first.

The heating temperature of the cleaning water is within the range of 35° C. to 75° C., but the heating temperature may also be subdivided into the range of 35° C. to 45° C. or the range of 65° C. to 75° C.

Afterwards, in the third step, after the source of pollution is soaked by repeatedly spraying the heated cleaning water onto the surface of the bowl 2a in an up-down swing manner via reciprocating horizontal rotation of the cleaning nozzle portion 10, in order to execute the next operating mode, i.e., the cleaning mode S20, the cleaning nozzle portion 10 is caused to return to the initial rotation angle after the cleaning nozzle portion 10 is stopped from rotating horizontally. Thus, the soaking mode S10 may be ended.

As shown in FIG. 8, the cleaning mode S20 is a mode of primarily removing, by means of brushing, the soaked source of pollution on the surface of the bowl 2a of the toilet 2 after the soaking mode S10. The cleaning mode S20 may include a fourth step and a fifth step.

As shown in FIG. 13, in the fourth step, the cleaning nozzle portion 10 may rotate repeatedly and horizontally by a first rotation angle (for example, an angle N). The cleaning nozzle portion 10 may rotate repeatedly and horizontally by a second rotation angle (for example, an angle N1) smaller than the first rotation angle (N>N1). Discharged flow is guided in a zigzag manner by the drainage chamber 31 of the spray guide portion 30 formed in the nozzle head 20. Thus, the surface of the bowl 2a may be cleaned by repeatedly spraying, in an up-down swing manner, hot cleaning water heated to be within the range of 35° C. to 75° C. (desirably 40° C.) onto part of divided areas of the surface of the bowl 2a through the spray hole 21 of the nozzle head 20.

Then, in the fifth step, at the time point when the cleaning nozzle portion repeatedly spraying the heated cleaning water in an up-down swing manner reaches a maximum rotation angle through repeated horizontal rotation from the first rotation angle to the second rotation angle, the cleaning nozzle portion 10 is caused to return to the initial rotation angle after the cleaning nozzle portion 10 is stopped from rotating horizontally. Thus, the cleaning mode S20 may be ended.

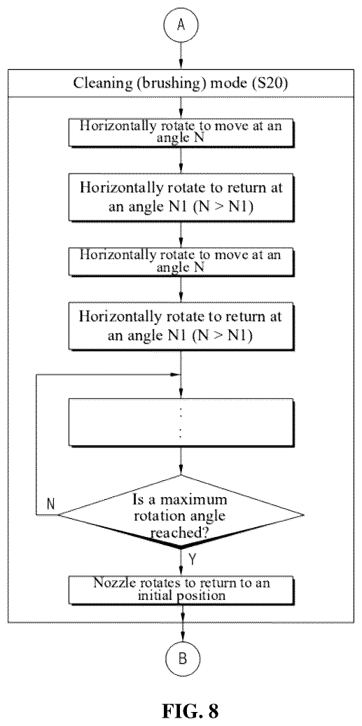

As shown in FIG. 9, the deep cleaning mode S30 is a mode of secondarily removing, by means of brushing, the source of pollution on the surface of the bowl 2a of the toilet 2 after the cleaning mode S20 and may include sixth to ninth steps.

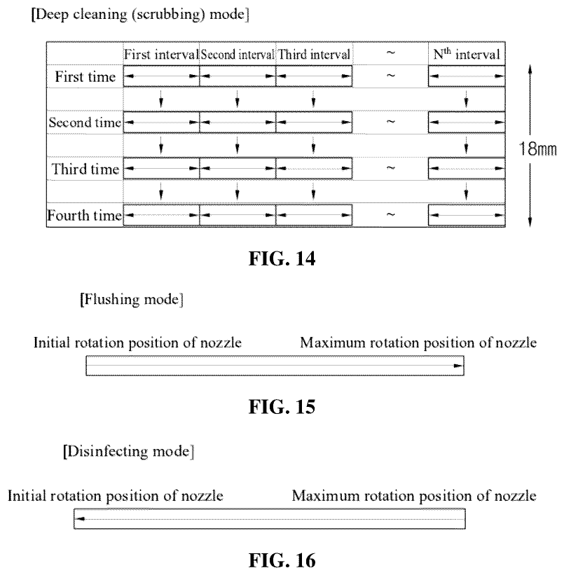

As shown in FIG. 14, in the sixth step, the cleaning nozzle portion 10 stored on one side of the bottom surface of the bidet body 1 is caused to reciprocate at a first rotation angle (for example, an angle N) to rotate horizontally. The discharged flow is guided in a zigzag manner by the drainage chamber 31 of the spray guide portion 30 formed in the nozzle head 20. Thus, hot cleaning water heated to be within the range of 35° C. to 75° C. (desirably 40° C.) may be repeatedly sprayed onto an upper side surface and a lower side surface of the bowl 2a in an up-down swing manner through the spray hole 21 of the nozzle head 20.

Next, in the seventh step, the cleaning nozzle portion 10 is caused to return to the initial rotation angle after the cleaning nozzle portion 10 is stopped from rotating horizontally. As shown in FIG. 14, in the following eighth step, the cleaning nozzle portion 10 is caused to reciprocate at a second rotation angle (for example, an angle N1) to rotate horizontally. The discharged flow is guided in a zigzag manner by the drainage chamber 31 of the spray guide portion 30 formed in the nozzle head 20. Thus, hot cleaning water heated to be within the range of 35° C. to 75° C. (desirably 40° C.) may be repeatedly sprayed onto a left side surface and a right side surface of the bowl 2a in an up-down swing manner through the spray hole 21 of the nozzle head 20.

In the following ninth step, the cleaning nozzle portion 10 is caused to return to the initial rotation angle after the cleaning nozzle portion 10 is stopped from rotating horizontally. In this case, the bidet control portion can repeatedly execute the sixth to ninth steps according to a preset number of times. Thus, all the sources of pollution may be removed from the surface of the bowl 2a of the toilet 2.

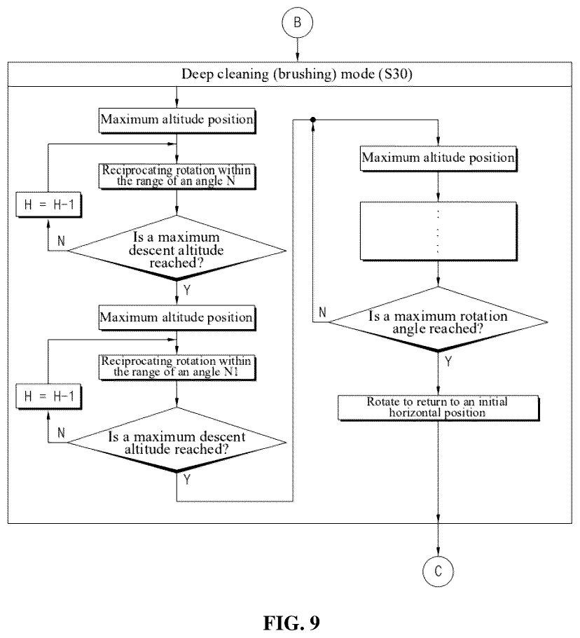

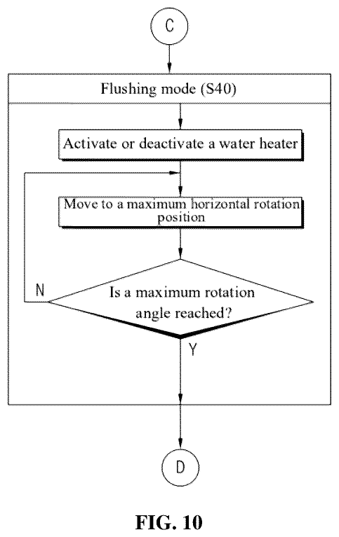

As shown in FIG. 10, the flushing mode S40 is a mode of removing the source of pollution remaining on the surface of the bowl 2a of the toilet 2 after the source of pollution is removed by the deep cleaning mode S30 and may include tenth and eleventh steps.

In the tenth step, the water heater is kept activated or is deactivated in step b to heat the cleaning water to be warm water within the range of 35° C. to 75° C. (desirably 40° C.) or to keep the cleaning water in an unheated room-temperature water state.

As shown in FIG. 15, in the following eleventh step, the cleaning nozzle portion 10 is caused to rotate horizontally at the maximum rotation angle. The discharged flow is guided in a zigzag manner by the first drainage chamber 31 and a second drainage chamber 32 of the spray guide portion 30 formed in the nozzle head 20. Thus, hot cleaning water heated to be within the range of 35° C. to 75° C. (desirably 40° C.) or unheated room-temperature water may be repeatedly sprayed onto the surface of the bowl 2a in an up-down swing manner through the spray hole 21 of the nozzle head 20 to remove the source of pollution remaining on the surface of the bowl 2a of the toilet 2.

As shown in FIG. 11, the disinfecting mode S50 is a mode of disinfecting the surface of the bowl 2a of the toilet 2 from which the remaining source of pollution is removed by the flushing mode S40 and may include twelfth to fourteenth steps.

In the twelfth step, when the water heater is kept activated or is deactivated, a disinfectant generating portion arranged inside the bidet body 1 is activated to generate a disinfectant (or electrolyzed water), and the disinfectant is heated to 35° C. or 75° C. (desirably 40° C.) or is unheated and kept in a normal temperature.

As shown in FIG. 16, in the following thirteenth step, the cleaning nozzle portion 10 that reaches a maximum extended distance is caused to rotate horizontally, and the discharged flow is guided in a zigzag manner by the drainage chamber 31 of the spray guide portion 30 formed in the nozzle head 20. Thus, the disinfectant heated to be within the range of 35° C. to 75° C. (desirably 40° C.) or the unheated disinfectant may be repeatedly sprayed onto the surface of the bowl 2a in an up-down swing manner through the spray hole 21 of the nozzle head 20 to complete cleaning of the bowl 2a of the toilet 2.

In the following fourteenth step, in the case where the water heater is activated, the water supply valve controlled to be opened in step a is controlled to be closed after the water heater and the disinfectant generating portion are deactivated, the cleaning nozzle portion 10 is stored on the bottom surface of the bidet body 1, and the bidet control portion finishes the sequence operating modes.

In an embodiment, the bidet control portion controls the sequence operating modes to be sequentially performed in the order of a soaking mode S10→a cleaning mode S20→a deep cleaning mode S30→a flushing mode S40→a disinfecting mode S50. When the source of pollution is cleaned from the bowl 2a of the toilet 2 using the cleaning water or the disinfectant, air may be mixed with the cleaning water or the disinfectant by an air pump in each of the sequence operating modes. In this case, an air mixing volume in the soaking mode S10, the flushing mode S40, and the disinfecting mode S50 is controlled to be a first mixing volume. An air mixing volume in the cleaning mode S20 and the deep cleaning mode S30 is controlled to be a second mixing volume larger than the first mixing volume. Thus, the efficiency of spraying the cleaning water or the disinfectant through the spray hole 21 of the nozzle head 20 in an up-down swing manner can be improved.

In an embodiment, the cleaning nozzle portion 10 sprays the cleaning water or the disinfectant in an up-down swing manner through horizontal rotation in an extended state in the sequence operating modes as described above, such as the soaking mode S10, the cleaning mode S20, the deep cleaning mode S30, the flushing mode S40, and the disinfecting mode S50. However, the sequence operating modes are not limited to the modes as described in the present disclosure. In the process that the cleaning nozzle portion 10 moves up and down from an initial storage position to the maximum extended distance of 180 mm or less, the cleaning nozzle portion 10 may rotate horizontally at the first rotation angle, the second rotation angle, or the maximum rotation angle of 360 degrees based on the initial rotation angle of 0 degrees, to spray the cleaning water or the disinfectant onto the surface of the bowl 2a of the toilet 2 in an up-down swing manner. Thus, the cleaning blind area on the surface of the bowl 2a may be minimized.

The technical concepts of the toilet bowl cleaning device and the toilet bowl cleaning method using the toilet bowl cleaning device according to the present disclosure have been explained in detail above with reference to the drawings, but these only illustrate the embodiments of the present disclosure, rather than limit the present disclosure.

In an embodiment, a toilet may include a base (e.g., a pedestal, a bowl, etc.) and a tank. The base is configured to be attached to another object such as a drainpipe, floor, or another suitable object. The base includes a bowl, a sump (e.g., a receptacle) disposed below the bowl, and a trapway fluidly connecting the bowl to a drainpipe or sewage line. The tank may be supported by the base, such as an upper surface of a rim. The tank may be integrally formed with the base as a single unitary body. In other embodiments, the tank may be formed separately from the base and coupled (e.g., attached, secured, fastened, connected, etc.) to the base. The toilet may further include a tank lid covering an opening and inner cavity in the tank. The toilet may include a seat assembly including a seat and a seat cover rotatably coupled to the base. The toilet arrangement may further include a hinge assembly.

In another embodiment, the toilet arrangement may be a tankless toilet. The toilet arrangement includes a base and a seat assembly coupled to the base. The base includes a bowl, a sump disposed below the bowl, and a trapway fluidly connecting the bowl to a drainpipe or sewage line. The toilet arrangement includes a waterline that supplies the toilet with water. The toilet may further include a seat assembly including a seat and a seat cover rotatably coupled to the base. The toilets described above are provided herein as non-limiting examples of toilets that may be configured to utilize aspects of the present disclosure.

In some examples, a bidet may be included in a seat or pedestal of a toilet. In other examples, the bidet may be manufactured separately from and attached or coupled to a seat or pedestal of a toilet. The bidet includes a housing. The housing is configured to receive a flow of water through a housing inlet and dispense the flow of water from a housing outlet. The housing inlet and housing outlet may be located on opposite ends of the housing from one another, such that water may flow through the housing from the housing inlet to the housing outlet. In some examples, the housing further includes a chamber. As the housing receives the flow of water, the chamber may fill with water and provide a flow of water between the housing inlet and the housing outlet. The chamber may be configured to contain the flow of water and direct the flow of water from the housing inlet to the housing outlet. After the chamber has filled with water, the flow of water may travel along a substantially linear path between the housing inlet and the housing outlet. In some examples, one or more walls within the housing may be included to help direct a flow of water between the housing inlet and the housing outlet. The bidet may further include a housing inlet conduit configured to direct a flow of water to the housing inlet. The housing inlet conduit may be coupled to a water supply such as tank or waterline. The housing may further include a gear assembly or a portion of the gear assembly. The bidet may be a front wash bidet for female users and may use, generate, and/perform the functions related to nanobubbles, ozonated water, eWater, hydrogen peroxide generation, pH Control, template assisted crystallization, application of polyphosphates, filtration (ultrafiltration, nanofiltration, microfiltration, carbon/GAC), fluidic oscillating sprays, and adding other consumables in the water stream. For nanobubbles, air, ozone, oxygen, hydrogen, and carbon dioxide may be used.

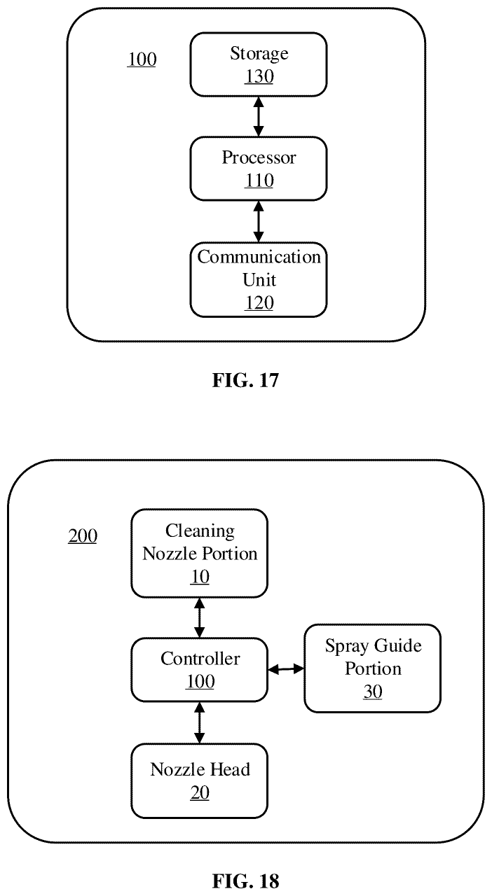

FIG. 17 is a block diagram of a controller according to an embodiment of the present disclosure. FIG. 18 is a block diagram of a toilet bowl cleaning device comprising the controller according to an embodiment of the present disclosure.

The controller herein may be configured to control the toilet bowl cleaning device to perform the toilet bowl cleaning method according to any of the embodiments, and the descriptions regarding the toilet bowl cleaning device and the toilet bowl cleaning method are incorporated herein. The toilet bowl cleaning device is configured to perform an operation, function, or the like as described in the present disclosure.

As shown in FIG. 17, a controller 100 comprises a processor 110, a communication unit 120 communicably connected to the processor 110, and a storage 130 communicably connected to the processor 110.

The controller 100 in the present disclosure can be implemented by any appliances or by any software or applications run by the appliances. The controller 100 may be connected to a workstation or another external device (e.g., control panel, remote) and/or a database for receiving user inputs, system characteristics, and any of the values described herein. Optionally, the controller 100 may include an input device and/or a sensing circuit in communication with any of the sensors. The sensing circuit receives sensor measurements from as described above. Optionally, the controller 100 may include a drive unit for receiving and reading non-transitory computer media having instructions. Additional, different, or fewer components may be included.

The processor 110 is configured to perform instructions stored in memory for executing the algorithms described herein. The processor 110 may be a general purpose or specific purpose processor, an application specific integrated circuit (ASIC), one or more programmable logic controllers (PLCs), one or more field programmable gate arrays (FPGAs), a group of processing components, or other suitable processing components. The processor 110 is configured to execute computer code or instructions stored in memory or received from other computer readable media (e.g., embedded flash memory, local hard disk storage, local ROM, network storage, a remote server, etc.). The processor 110 may be a single device or combinations of devices, such as associated with a network, distributed processing, or cloud computing.

The communication unit 120 may include any operable connection, ingress ports, and egress ports. An operable connection may be one in which signals, physical communications, and/or logical communications may be sent and/or received. An operable connection may include a physical interface, an electrical interface, and/or a data interface. The communication unit 120 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

In an embodiment, the storage 130 may include one or more devices (e.g., memory units, memory devices, storage devices, etc.) for storing data and/or computer code for completing and/or facilitating the various processes described in the present disclosure. The storage 130 may include random access memory (RAM), read-only memory (ROM), hard drive storage, temporary storage, non-volatile memory, flash memory, optical memory, or any other suitable memory for storing software objects and/or computer instructions. The storage 130 may include database components, object code components, script components, or any other type of information structure for supporting the various activities and information structures described in the present disclosure. The storage 130 may be communicably connected to processor via a processing circuit and may include computer code for executing (e.g., by processor) one or more processes described herein. For example, the storage 130 may include graphics, web pages, HTML files, XML files, script code, shower configuration files, or other resources for use in generating graphical user interfaces for display and/or for use in interpreting user interface inputs to make command, control, or communication decisions.

As shown in FIG. 18, a toilet bowl cleaning device 200 may comprise the controller 100 as described above. The toilet bowl cleaning device 200 may be the toilet bowl cleaning device according to any of the embodiments, and the descriptions regarding the toilet bowl cleaning device are incorporated herein. The toilet bowl cleaning device is configured to perform an operation, function, or the like as described in the present disclosure.

The toilet bowl cleaning device 200 includes a cleaning nozzle portion 10, a nozzle head 20, and a spray guide portion 30, each of which is communicably connected to the controller 100.

Therefore, the present disclosure is not limited to the above specific embodiments, and those having ordinary skill in the art to which the present disclosure pertains may implement various modifications without exceeding the gist of the present disclosure as claimed in the claims, and these modifications are also within the scope of the claims.

List of reference signs

| | |
|---|---|
| 1: | Bidet body |
| 2: | Toilet |
| 2a: | Bowl |
| 10: | Cleaning nozzle portion |
| 11: | First cylindrical portion |
| 11a: | Water intake portion |
| 11b: | Opening |
| 12: | Second cylindrical portion |
| 12a: | Water outlet portion |
| 13: | Connecting portion |
| 13a: | Key slot |
| 13b: | Sealing gasket groove |
| 14: | Key |
| 15: | Sealing gasket |
| 20: | Nozzle head |
| 21: | Spray hole |
| 22: | Water intake hole |
| 30: | Spray guide portion |
| 31: | Drainage chamber |
| U1: | First internal flow path |
| U2: | Second internal flow path |
| U3: | Third internal flow path |

1-21. (canceled)

22. A toilet bowl cleaning device, comprising:
a cleaning nozzle portion disposed on a bottom surface of a bidet body of a toilet, the cleaning nozzle portion configured to extend and horizontally rotate, and the cleaning nozzle portion including a water intake portion and a water outlet portion; and
a nozzle head disposed on the water outlet portion of the cleaning nozzle portion and configured to spray cleaning water or a disinfectant onto a surface of a bowl of the toilet through a spray hole of the nozzle head,
wherein the nozzle head comprises a spray guide portion configured to guide a discharged flow of the cleaning water or the disinfectant in a zigzag manner so that the cleaning water or the disinfectant is sprayed in an up-down swing manner through the spray hole.

23. The toilet bowl cleaning device according to claim 22, wherein the cleaning nozzle portion comprises:
a first cylindrical portion including the water intake portion configured to be connected to a cleaning water supply pipeline in the bidet body and including a first internal flow path;
a second cylindrical portion including the water outlet portion and a second internal flow path in fluid communication with the first internal flow path; and
a connecting portion protruding at an end of the second cylindrical portion and configured to guide an inserting combination of the first cylindrical portion, the connecting portion including a third internal flow path in fluid communication with the first internal flow path and the second internal flow path.

24. The toilet bowl cleaning device according to claim 23, further comprising:
an opening disposed in an outer peripheral surface of the first cylindrical portion;
a key slot disposed in an outer peripheral surface of the connecting portion; and
a key configured to be disposed in the key slot through the opening so as to connect the first cylindrical portion to the connecting portion.

25. The toilet bowl cleaning device according to claim 24,
wherein the opening has a C-shaped hole structure, and
wherein the key has a C-shaped ring structure configured to be disposed in the key slot through the opening.

26. The toilet bowl cleaning device according to claim 24, further comprising:
a sealing gasket groove disposed in the outer peripheral surface of the connecting portion; and
a sealing gasket configured to be clung to an inner peripheral surface of the first cylindrical portion and disposed in the sealing gasket groove.

27. The toilet bowl cleaning device according to claim 23,
wherein the water outlet portion has a slot structure and is in fluid communication with the second internal flow path of the second cylindrical portion,
wherein the water outlet portion comprises an installation space configured to allow cleaning water or the disinfectant to flow,
wherein the nozzle head is configured to insert into the water outlet portion,
wherein the nozzle head comprises a water intake hole in fluid communication with the installation space, and
wherein the spray guide portion is formed between the water intake hole and the spray hole.

28. The toilet bowl cleaning device according to claim 27,
wherein the spray guide portion is a ribbed block and is in fluid communication with the water intake hole to spray the cleaning water or the disinfectant from the spray hole in the up-down swing manner, and
wherein the spray guide portion comprises a drainage chamber to configured to guide the discharged flow of the cleaning water or the disinfectant in the zigzag manner.

29. A toilet bowl cleaning method for cleaning a bowl by a toilet bowl cleaning device, the method comprising:
controlling, in response to an input signal of a cleaning button, a water supply valve in a bidet body to be opened to supply cleaning water;
heating the cleaning water by activating a water heater in the bidet body when the cleaning water is supplied into the bidet body; and
when the cleaning water heated by the water heater reaches a target water temperature, spraying the cleaning water or a disinfectant onto a surface of the bowl in an up-down swing manner through a spray hole by controlling a plurality of sequence operating modes to apply a physical impact onto the surface of the bowl.

30. The toilet bowl cleaning method according to claim 29,
wherein controlling the plurality of sequence operating modes to apply the physical impact onto the surface of the bowl comprises:
determining whether the disinfectant is introduced into a cleaning nozzle portion of the toilet bowl cleaning device and whether to mix air with the cleaning water or the disinfectant; and
changing an extended distance and a horizontal rotation angle of the cleaning nozzle portion.

31. The toilet bowl cleaning method according to claim 30,
wherein the plurality of sequence operating modes comprises a soaking mode, a cleaning mode, a deep cleaning mode, a flushing mode, and a disinfecting mode, and
wherein controlling the plurality of sequence operating modes to apply the physical impact onto the surface of the bowl comprises:
sequentially executing the soaking mode, the cleaning mode, the deep cleaning mode, the flushing mode, and the disinfecting mode.

32. The toilet bowl cleaning method according to claim 31,
wherein the soaking mode is a mode of soaking a source of pollution attached to the surface of the bowl, and
wherein executing the soaking mode comprises:
in a first step, controlling the cleaning nozzle portion disposed on a bottom surface of the bidet body to extend;
in a second step, controlling the extended cleaning nozzle portion repeatedly and horizontally rotate between an initial rotation angle and a maximum rotation angle, guiding a discharged flow in a zigzag manner by a spray guide portion in a nozzle head, and repeatedly spraying the heated cleaning water onto the surface of the bowl in the up-down swing manner through the spray hole; and
in a third step, when the heated cleaning water is repeatedly sprayed onto the surface of the bowl in the up-down swing manner by repeatedly and horizontally rotating the cleaning nozzle portion, controlling the cleaning nozzle portion to return to the initial rotation angle after the cleaning nozzle portion stops horizontally rotating.

33. The toilet bowl cleaning method according to claim 32,
wherein the cleaning mode is a mode of removing, by brushing the surface of the bowl, the soaked source of pollution on the surface of the bowl after the soaking mode, and
wherein executing the cleaning mode comprises:
in a fourth step, controlling the cleaning nozzle portion to repeatedly and horizontally rotate by a first rotation angle and by a second rotation angle smaller than the first rotation angle, dividing the surface of the bowl into partial areas, repeatedly cleaning the partial areas, guiding the discharged flow in the zigzag manner by the spray guide portion in the nozzle head, and repeatedly spraying the heated cleaning water in the up-down swing manner through the spray hole; and
in a fifth step, when the cleaning nozzle portion repeatedly spraying the heated cleaning water in the up-down swing manner reaches a maximum rotation angle by repeatedly and horizontally rotating the cleaning nozzle portion by the first rotation angle and the second rotation angle, controlling the cleaning nozzle portion to return to the initial rotation angle after the cleaning nozzle portion stops horizontally rotating.

34. The toilet bowl cleaning method according to claim 33,
wherein the deep cleaning mode is a mode of secondarily removing, by brushing the surface of the bowl, the source of pollution on the surface of the bowl after the cleaning mode, and
wherein executing the deep cleaning mode comprises:
in a sixth step, controlling the cleaning nozzle portion to repeatedly and horizontally rotate within a range of the first rotation angle, guiding the discharged flow in the zigzag manner by the spray guide portion in the nozzle head, and repeatedly spraying the heated cleaning water onto an upper side surface and a lower side surface of the bowl in the up-down swing manner through the spray hole;
in a seventh step, controlling the cleaning nozzle portion to return to the initial rotation angle after the cleaning nozzle portion stops rotating horizontally;
in an eighth step, controlling the cleaning nozzle portion to repeatedly and horizontally rotate within a range of the second rotation angle, guiding the discharged flow in the zigzag manner by the spray guide portion in the nozzle head, and repeatedly spraying the heated cleaning water onto a left side surface and a right side surface of the bowl in the up-down swing manner through the spray hole; and
in a ninth step, controlling the cleaning nozzle portion to return to the initial rotation angle after the cleaning nozzle portion stops horizontally rotating, and repeatedly executing the sixth to ninth steps for a preset number of times.

35. The toilet bowl cleaning method according to claim 34,
wherein the flushing mode is a mode of removing the source of pollution on the surface of the bowl after the source of pollution is removed in the deep cleaning mode, and
wherein executing the flushing mode comprises:
in a tenth step, keeping the water heater activated to heat the cleaning water or deactivating the water heater to stop heating the cleaning water; and
in an eleventh step, controlling the cleaning nozzle portion to horizontally rotate by the maximum rotation angle, guiding the discharged flow in the zigzag manner by the spray guide portion in the nozzle head, and repeatedly spraying the heated cleaning water or unheated room-temperature cleaning water onto the surface of the bowl in the up-down swing manner through the spray hole.

36. The toilet bowl cleaning method according to claim 35,
wherein the disinfecting mode is a mode of disinfecting the surface of the bowl after the source of pollution is removed in the flushing mode, and
wherein executing the disinfecting mode comprises:
in a twelfth step, when the water heater is kept activated or is deactivated in the tenth step, activating a disinfectant generating portion disposed inside the bidet body to generate a disinfectant, and heating or not heating the disinfectant;
in a thirteenth step, controlling the cleaning nozzle portion reaching a maximum extended distance to rotate horizontally, guiding the discharged flow in the zigzag manner by the spray guide portion in the nozzle head, and repeatedly spraying the heated disinfectant or unheated room-temperature disinfectant onto the surface of the bowl in the up-down swing manner through the spray hole; and
in a fourteenth step, when the water heater is activated in the twelfth step, closing the water supply valve after deactivating the water heater and the disinfectant generating portion.

37. The toilet bowl cleaning method according to claim 36,
wherein, in the soaking mode, the cleaning mode, and the deep cleaning mode, the heated cleaning water sprayed in the up-down swing manner through the spray hole has a temperature from 35° C. to 75° C.

38. The toilet bowl cleaning method according to claim 36,
wherein, in the flushing mode and the disinfecting mode, the heated room-temperature cleaning water or the unheated cleaning water sprayed in the up-down swing manner through the spray hole has a temperature from 35° C. to 75° C. or room-temperature.

39. The toilet bowl cleaning method according to claim 36, further comprising:
in the soaking mode, the cleaning mode, the deep cleaning mode, the flushing mode, and the disinfecting mode, when the cleaning water flows into the nozzle head, mixing the cleaning water with air by an air pump disposed inside the bidet body.

40. The toilet bowl cleaning method according to claim 39, further comprising:
controlling an air mixing volume in the soaking mode, the flushing mode, and the disinfecting mode to be a first mixing volume; and
controlling an air mixing volume in the cleaning mode and the deep cleaning mode to be a second mixing volume greater than the first mixing volume.

41. The toilet bowl cleaning method according to claim 36,
wherein in the disinfecting mode, the disinfectant generated by the disinfectant generating portion is electrolyzed water generated by electrolysis.
